(19) United States
(12) Patent Application Publication
(10) Pub. No.: US 2026/0107121 A1
(43) Pub. Date: Apr. 16, 2026

(54) METHOD AND APPARATUS FOR COMMUNICATION USING ISOCHRONOUS INTERVAL BASED GROUP POLLING IN SHORT-RANGE WIRELESS COMMUNICATION SYSTEM

(71) Applicant: LG ELECTRONICS INC., Seoul (KR)

(72) Inventors: Hyeonjae LEE, Seoul (KR); Minsoo LEE, Seoul (KR)

(73) Assignee: LG ELECTRONICS INC., Seoul (KR)

(21) Appl. No.: 19/412,395

(22) Filed: Dec. 8, 2025

(30) Foreign Application Priority Data
Oct. 8, 2024 (KR) 10-2024-0136959

(51) Int. Cl. H04W 4/80; H04W 76/10

(52) U.S. Cl. CPC H04W 4/80; H04W 76/10

(57) ABSTRACT

The present disclosure relates to a short-range wireless communication system, and more specifically, to a communication method and device for efficiently collecting input data from peripheral devices, such as gamepads and headsets, and reducing Periodic Advertising (PA) traffic by performing group polling between a first device and at least one second device on an isochronous link comprising an Isochronous Interval (ISO Interval).

### CROSS-REFERENCE TO RELATED APPLICATIONS

Pursuant to 35 U.S.C. § 119, this application claims the benefit of earlier filing date and right of priority to Korean Application No. 10-2024-0136959, filed on Oct. 8, 2024, the contents of which are all incorporated by reference herein in their entirety.

### TECHNICAL FIELD

The present disclosure relates to a short-range wireless communication system, and more specifically, to a communication method and device for efficiently collecting input data from peripheral devices, such as gamepads and headsets, and reducing Periodic Advertising (PA) traffic by performing group polling between a first device and at least one second device on an isochronous link comprising an Isochronous Interval (ISO Interval).

### BACKGROUND ART

In a short-range wireless communication system, for example, a system complying with a low-power short-range wireless standard, isochronous communication is supported to allow time-sensitive data such as audio data or input data to be transmitted within a constant period and latency range. Such isochronous communication may be classified into a broadcast method and a unicast method.

In the broadcast isochronous method, a first device, for example, a central device, periodically broadcasts an isochronous stream, and one or more receiving devices (gamepads, headsets, etc.) operate by receiving it. In this case, while it is advantageous for unidirectional data transmission from the central device to peripheral devices, there is a problem that it is not suitable for uses such as collecting input data because a reverse data transmission path from the peripheral devices to the central device is not provided or is limited.

On the other hand, in the unicast isochronous method, individual unicast links are established between the first device and each second device, and a structure is used in which the first device transmits a poll packet for each Subevent or sub-interval, and the second device transmits a data packet in response thereto. In such a structure, since a poll packet is generated for each Subevent, there is an advantage of precise link control, but there are problems in that the transmission/reception activity of the first device excessively increases, and battery consumption and scheduling complexity significantly increase. Particularly in an environment where a game console and multiple gamepads or headsets are simultaneously connected, performing a poll for every Subevent is inefficient.

In addition, in the short-range wireless communication system, Periodic Advertising (PA) is used to synchronize one or more peripheral devices to the isochronous timing of the central device. To this end, the central device repeatedly transmits an advertising chain including extended advertising packets (e.g., ADV_EXT_IND) and auxiliary advertising packets (e.g., AUX_ADV_IND, AUX_SYNC_SUBEVENT_IND) to continuously provide synchronization information to potential receiving devices whose presence time is unknown. However, if the same advertising chain is maintained for a long time even after a specific peripheral device has already synchronized to the PA, there is a problem that the proportion of advertising traffic in the total bandwidth increases when the PA interval is set short, and effective time resources for data transmission decrease.

Therefore, in an environment where input traffic from peripheral devices such as game inputs is dominant, there is a need for a new communication method capable of stably collecting input data across multiple Subevents while reducing the poll overhead of the central device, and reducing unnecessary PA traffic for peripheral devices for which synchronization is already completed.

### DISCLOSURE

### Technical Problem

To solve the above-mentioned problems, the present disclosure provides a device and method for receiving input data from peripheral devices in each of a plurality of Subevent intervals constituting the ISO Interval, while using only a single group poll packet associated with one ISO Interval on an isochronous link.

The present disclosure provides a device and method for efficiently sharing the same isochronous resource among multiple devices by receiving response packets from a plurality of peripheral devices in an interleaving manner in an environment where multiple Subevent intervals exist within one ISO Interval.

To ensure reliability of input data, the present disclosure provides a device and method that support Simple repetition of a same report or Historic repetition of transmitting a previous report together with a current report, allowing the central device to reconstruct an accurate input state even in the event of packet loss or intermittent errors.

The present disclosure provides a device and method for providing a sufficient user experience while reducing downlink traffic by including an Output Report of the central device, for example, output information such as vibration control information, in the group poll packet, but including it once per a plurality of ISO Intervals instead of transmitting it every ISO Interval.

The present disclosure provides a device and method for reducing unnecessary advertising overhead for already synchronized devices by allowing a peripheral device to transmit an Acknowledgment (Ack) signal indicating that synchronization is completed in a Periodic Advertising-based synchronization procedure, and in response thereto, causing the central device to discontinue transmission of specific advertising components, for example, AUX_EXT_IND or AUX_ADV_IND.

The technical problems to be achieved in the present disclosure are not limited to the technical problems mentioned above, and other technical problems not mentioned will be clearly understood by those skilled in the art to which the present disclosure belongs from the following description.

### Technical Solution

According to various embodiments of the present disclosure, in a method performed by a first device in a short-range wireless communication system, there is provided a method comprising: transmitting, to at least one second device, a single group poll packet associated with one Isochronous Interval (ISO Interval), wherein the ISO Interval comprises a plurality of Subevent intervals; and in response to the single group poll packet, receiving, from the at least one second device, a plurality of response packets corresponding to each of the plurality of Subevent intervals, wherein the group poll packet operates as a single poll for an entirety of the plurality of Subevent intervals.

According to various embodiments of the present disclosure, in a method performed by a second device in a short-range wireless communication system, there is provided a method comprising: receiving, from a first device, a single group poll packet associated with one Isochronous Interval (ISO Interval), wherein the ISO Interval comprises a plurality of Subevent intervals; and in response to the single group poll packet, transmitting, to the first device, a plurality of response packets corresponding to each of the plurality of Subevent intervals, wherein the group poll packet operates as a single poll for an entirety of the plurality of Subevent intervals.

According to various embodiments of the present disclosure, in a first device in a short-range wireless communication system, there is provided a first device comprising: a first processor corresponding to a host stack; a second processor corresponding to a controller stack; a memory; and a transceiver, wherein the host stack and the controller stack are connected via a Host Controller Interface (HCI), wherein the memory stores instructions that, when executed by the first processor and the second processor, cause the first device to perform operations comprising: transmitting, to at least one second device, a single group poll packet associated with one Isochronous Interval (ISO Interval), wherein the ISO Interval comprises a plurality of Subevent intervals; and in response to the single group poll packet, receiving, from the at least one second device, a plurality of response packets corresponding to each of the plurality of Subevent intervals, wherein the group poll packet operates as a single poll for an entirety of the plurality of Subevent intervals.

### Advantageous Effects

In order to solve the above-described problem, the present disclosure can provide a device and method for receiving input data from peripheral devices in each of a plurality of Subevent intervals constituting the ISO Interval, while using only a single group poll packet associated with one ISO Interval on an isochronous link.

The present disclosure can provide a device and method for efficiently sharing the same isochronous resource among multiple devices by receiving response packets from a plurality of peripheral devices in an interleaving manner in an environment where multiple Subevent intervals exist within one ISO Interval.

To ensure reliability of input data, the present disclosure can provide a device and method that support Simple repetition of a same report or Historic repetition of transmitting a previous report together with a current report, allowing the central device to reconstruct an accurate input state even in the event of packet loss or intermittent errors.

The present disclosure can provide a device and method for providing a sufficient user experience while reducing downlink traffic by including an Output Report of the central device, for example, output information such as vibration control information, in the group poll packet, but including it once per a plurality of ISO Intervals instead of transmitting it every ISO Interval.

The present disclosure can provide a device and method for reducing unnecessary advertising overhead for already synchronized devices by allowing a peripheral device to transmit an Acknowledgment (Ack) signal indicating that synchronization is completed in a Periodic Advertising-based synchronization procedure, and in response thereto, causing the central device to discontinue transmission of specific advertising components, for example, AUX_EXT_IND or AUX_ADV_IND.

### DESCRIPTION OF DRAWINGS

The accompanying drawings, which are to provide a further understanding of the present disclosure, can provide embodiments of the present disclosure together with the detailed description. However, technical features of the present disclosure are not limited to specific drawings and features disclosed in the respective drawings may be combined with each other to constitute a new embodiment. Reference numerals in each drawing may refer to structural elements.

FIG. 1 is a schematic view illustrating an example of a wireless communication system using a Bluetooth low energy technology to which the present disclosure is applicable.

FIG. 2 illustrates an example of an internal block diagram of a device capable of implementing methods proposed by the present disclosure.

FIG. 3 illustrates an example of a Bluetooth communication architecture to which methods proposed by the present disclosure may be applied.

FIG. 4 illustrates an example of a structure of a generic attribute profile (GATT) of Bluetooth low energy.

FIG. 5 is a flowchart showing an example of a connection procedure method in Bluetooth low energy technology to which the present disclosure may be applied.

FIG. 6 illustrates an example of a timing relationship in which an ADV_EXT_IND packet, an AUX_ADV_IND packet, and an AUX_SYNC_IND packet are arranged on a Periodic Advertising event and a Periodic Advertising interval.

FIG. 7 illustrates an example of a packet connection structure of a Periodic Advertising chain consisting of ADV_EXT_IND, AUX_ADV_IND, and AUX_SYNC_SUBEVENT_IND.

FIG. 8 illustrates an example of a structure in which a plurality of response slots are arranged according to a plurality of Subevents, Periodic Advertising response slot delay, and response slot spacing within a Periodic Advertising interval.

FIG. 9 illustrates an example of a timing relationship in which AUX_SYNC_SUBEVENT_IND or AUX_CONNECT_REQ is transmitted for a specific Subevent selected in a PAwR event, and AUX_SYNC_SUBEVENT_RSP PDUs corresponding thereto are arranged in Periodic Advertising response slots.

FIG. 10 illustrates another example of a Periodic Advertising structure in which ADV_EXT_IND of a primary advertising channel and AUX_ADV_IND and AUX_SYNC_SUBEVENT_IND of a secondary advertising channel are continuously transmitted.

FIG. 11 illustrates an example of a PAST (Periodic Advertising Sync Transfer) procedure for transmitting Periodic Advertising synchronization information and PAwR related parameters from Device A to Device B through an LE-ACL connection.

FIG. 12 illustrates an example of a broadcast isochronous stream in which a plurality of sub-intervals are arranged at equal intervals within an Isochronous Interval (ISO Interval).

FIG. 13 illustrates an example of a conventional polling method in which a poll packet of a central device and a data packet of a peripheral device are exchanged on a one-to-one basis in each sub-interval in a unicast isochronous link.

FIG. 14 illustrates an example of a group polling method (proposed method) in which an Input Report of a peripheral device is transmitted in a plurality of sub-intervals in response to a single poll performed at the beginning of one Isochronous Interval (ISO Interval).

FIG. 15 illustrates an example of a group polling operation in which a plurality of gamepads (HID devices) transmit Input Reports in an interleaving manner for each sub-interval in response to a single poll in one Isochronous Interval (ISO Interval).

FIG. 16 illustrates an example of a procedure in which a central device transmits a Periodic Advertising (PA) packet including ADV_EXT_IND, AUX_ADV_IND, AUX_SYNC_SUBEVENT_IND, etc., and peripheral devices such as a gamepad and a headset transmit AUX_SYNC_SUBEVENT_RSP as an Acknowledgment (Ack) signal to notify completion of PA synchronization.

FIG. 17 illustrates an example of an operation process of a wireless device in the short-range wireless communication system according to various embodiments of the present disclosure.

FIG. 18 illustrates an example of an operation process of a wireless device in the short-range wireless communication system according to various embodiments of the present disclosure.

### MODES FOR DISCLOSURE

In various embodiments of the present disclosure, “A or B” may mean “only A,” “only B,” or “both A and B”. In other words, “A or B” may be interpreted as “A and/or B” in various embodiments of the present disclosure. For example, in various embodiments of the present disclosure, “A, B or C” can mean “only A,” “only B,” “only C,” or “any combination of A, B, and C”.

A slash (/) or a comma used in various embodiments of the present disclosure may mean “and/or”. For example, “A/B” may mean “A and/or B”. Accordingly, “A/B” may mean “only A,” “only B,” or “both A and B”. For example, “A, B, C” may mean “A, B, or C”.

In various embodiments of the present disclosure, “at least one of A and B” may mean “only A,” “only B,” or “both A and B”. Further, in various embodiments of the present disclosure, the expression “at least one of A or B” or “at least one of A and/or B” may be interpreted the same as “at least one of A and B”.

Further, in various embodiments of the present disclosure, “at least one of A, B and C” may mean “only A,” “only B,” “only C”, or “any combination of A, B and C”. Further, in various embodiments of the present disclosure, the expression “at least one of A, B or C” or “at least one of A, B and/or C” may be interpreted the same as “at least one of A, B and C”.

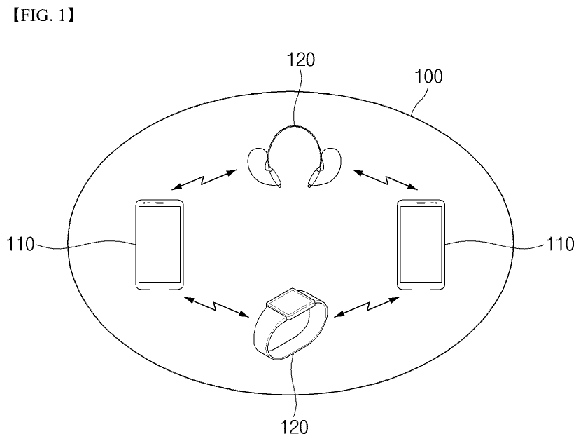

FIG. 1 is a schematic view illustrating an example of a wireless communication system using a Bluetooth low energy technology to which the present disclosure is applicable.

A wireless communication system 100 includes at least one server device 120 and at least one client device 110.

The server device and the client device perform Bluetooth communication using a Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Also, in the BLE technology, an inter-device connection procedure is simplified and a packet size is designed to be small compared with the Bluetooth BR/EDR technology.

In the BLE technology, (1) the number of RF channels is forty, (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may be expressed as a data service device, a slave device, a slave, a server, a conductor, a host device, a gateway, a sensing device, a monitoring device, a first device, a second device, etc.

The client device 110 may be expressed as a master device, a master, a client, a member, a sensor device, a sink device, a collector, a third device, a fourth device, etc.

The server device and the client device correspond to main components of the wireless communication system and the wireless communication system may include other components other than the server device and the client device.

The server device refers to a device that receives data from the client device, communicates directly with the client device, and provides data to the client device through a response when receiving a data request from the client device.

Further, the server device sends a notice/notification message and an indication message to the client device in order to provide data information to the client device. In addition, when the server device transmits the indication message to the client device, the server device receives a confirm message corresponding to the indication message from the client device.

Further, the server device may provide the data information to a user through a display unit or receive a request input from the user through a user input interface in the process of transmitting and receiving the notice, indication, and confirm messages to and from the client device.

In addition, the server device may read data from a memory unit or write new data in the corresponding memory unit in the process of transmitting and receiving the message to and from the client device.

Further, one server device may be connected to multiple client devices and may be easily reconnected to the client devices by using bonding information.

The client device 120 refers to a device that requests the data information or data transmission to the server device.

The client device receives the data from the server device through the notice message, the indication message, etc., and when receiving the indication message from the server device, the client device sends the confirm message in response to the indication message.

Similarly, the client device may also provide information to the user through the display unit or receive an input from the user through the user input interface in the process of transmitting and receiving the messages to and from the server device.

In addition, the client device may read data from the memory unit or write new data in the corresponding memory unit in the process of transmitting and receiving the message to and from the server device.

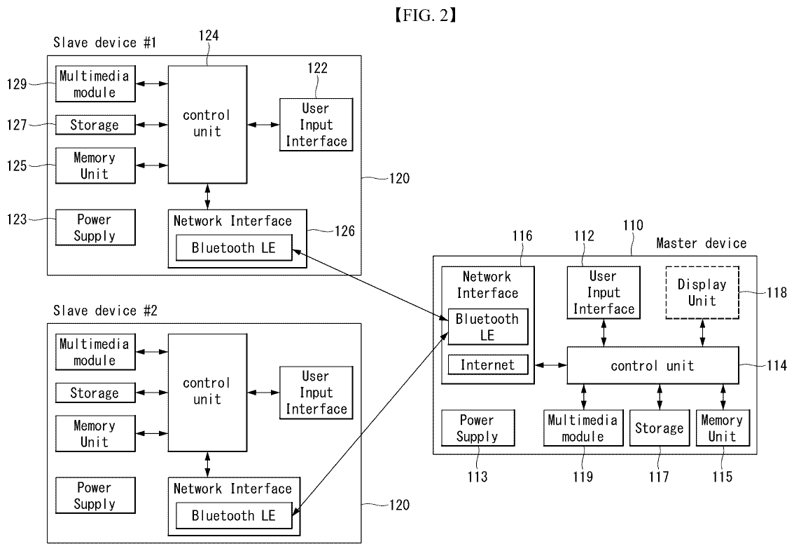

Hardware components such as the display unit, the user input interface, and the memory unit of the server device and the client device will be described in detail in FIG. 2.

Further, the wireless communication system may configure personal area networking (PAN) through Bluetooth technology. As an example, in the wireless communication system, a private piconet between the devices is established to rapidly and safely exchange files, documents, and the like.

FIG. 2 illustrates an example of an internal block diagram of a device capable of implementing methods proposed by the present disclosure.

As shown in FIG. 2, the master device 110 includes a user input interface 112, a power supply unit 113, a control unit 114, a memory unit 115), a network interface including a Bluetooth interface (Network Interface, 116), a storage (Storage, 117), an output unit (Display Unit, 118), and a multimedia module (Multi media Module, 119).

A network interface including the input unit (User Input Interface, 112), the power supply unit (Power Supply Unit, 113), the control unit (Control Unit, 114), the memory (Memory Unit, 115), and a Bluetooth interface (Bluetooth Interface) (Network Interface, 116), storage (Storage, 117), output unit (Display Unit, 118), and multimedia module (Multi media Module, 119) are functionally connected to each other to perform the method proposed in this specification.

In addition, as shown in FIG. 2, the slave devices (#1 and #2) 120 include an input unit (User Input Interface) 122, a power supply unit (Power Supply Unit) 123, a control unit (Control Unit, 124), memory (Memory Unit, 125), network interface (Network Interface, 126) including Bluetooth interface, storage (Storage, 127), output unit (Display Unit, 128), multi media module (Multi media Module, 129).

A network interface including the input unit (User Input Interface, 122), the power supply unit (Power Supply Unit, 123), the control unit (Control Unit, 124), the memory (Memory Unit, 125), and a Bluetooth interface (Bluetooth Interface) (Network Interface, 126), storage (Storage, 127), output unit (Display Unit, 128), and multimedia module (Multi media Module, 129) are functionally connected to each other to perform the method proposed in this specification.

The network interfaces 116 and 126 refer to units (or modules) capable of transmitting requests/responses, commands, notifications, instruction/confirmation messages, etc., or data between devices using Bluetooth technology.

The memories 115 and 125 are units implemented in various types of devices and refer to units in which various types of data are stored. Also, the storages 117 and 127 refer to units that perform a function similar to that of a memory.

The controllers 114 and 124 refer to a module that controls the overall operation of the master device 110 or the slave device 120, requests to transmit a message to a network interface, or controls to process a received message.

The controllers 114 and 124 may include an application-specific integrated circuit (ASIC), another chipset, a logic circuit, and/or a data processing device.

The memories 115 and 125 may include read-only memory (ROM), random access memory (RAM), flash memory, memory card, storage medium, and/or other storage devices.

The memories 115 and 125 may be inside or outside the processors 114 and 124, and may be connected to the processors 114 and 124 by various well-known means.

The output units 118 and 128 refer to modules for providing device status information and message exchange information to users through screens.

The power supply unit (power supply unit, 113, 123) refers to a module that receives external power and internal power under the control of the control unit and supplies power necessary for the operation of each component.

As discussed above, the BLE technology has a small duty cycle and can greatly reduce power consumption through a low data rate.

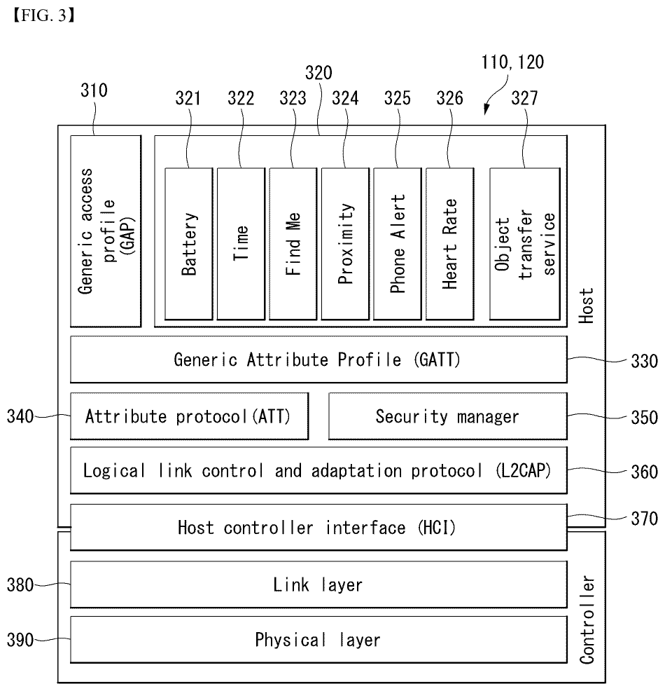

FIG. 3 illustrates an example of a Bluetooth communication architecture to which methods proposed by the present disclosure may be applied.

Specifically, FIG. 3 illustrates an example of an architecture of Bluetooth low energy (LE).

As shown in FIG. 3, the BLE structure includes a controller stack capable of processing a wireless device interface for which timing is critical and a host stack capable of processing high level data.

The controller stack may also be called a controller. In order to avoid confusion with the processor, that is, an internal element of the device described with reference to FIG. 2, however, the controller stack may be preferably used below.

First, the controller stack may be implemented using a communication module which may include a Bluetooth wireless device and a processor module which may include a processing device, such as a microprocessor.

The host stack may be implemented as part of an OS operating on the processor module or as a package instance on an OS.

In some cases, the controller stack and the host stack may operate or may be performed on the same processing device within the processor module.

The host stack includes a generic access profile (GAP) 310, GATT based profiles 320, a generic attribute profile (GATT) 330, an attribute protocol (ATT) 340, a security manager (SM) 350, and a logical link control and adaptation protocol (L2CAP) 360. The host stack is not limited to the aforementioned composition, but may include various protocols and profiles.

The host stack multiplexes various protocols and profiles provided by that Bluetooth disclosure using the L2CAP.

First, the L2CAP 360 provides one bilateral channel for sending data to according to a specific protocol or specific profile.

The L2CAP is capable of multiplexing data between upper layer protocols, segmenting or reassembling packages, and managing multicast data transmission.

BLE uses three fixed channels for respective signaling, a security manager, and an attribute protocol.

BR/EDR uses a dynamic channel and supports a protocol service multiplexer, retransmission, streaming mode.

The SM 350 authenticates a device, which is a protocol for providing a key distribution.

The ATT 340 relies on a server-client structure, which defines rules for a corresponding device for data access. Six message types are defined: Request, Response, Command, Notification, Indication, and Confirmation.

\textcircled{1} Request and Response message: the Request message is used when a client device requests specific information from a server device, and the Response message is used in response to a Request message, which is transmitted from the server device to the client device.

\textcircled{2} Command message: The Command message is transmitted from a client device to a server device in order to indicate a command for a specific operation, but the server device does not send a response to a Command message to the client device.

\textcircled{3} Notification message: A server device sends this message to a client device in order to provide notification of an event, but the client device does not send a confirmation message to the server device in response to a Notification message.

\textcircled{4} Indication and Confirm message: A server device sends this message to a client device in order to provide notification of an event. Unlike in the Notification message, the client device sends a Confirm message to the server device in response to an Indication message.

The generic access profile (GAP) is a layer newly implemented to support the BLE technology, and is used to control the selection of a role for communication between BLE devices and a multi-profile operation.

The GAP is mainly used for device discovery, connection establishment, and security. That is, the GAP defines a method for providing information to a user and also defines the following attribute types.
\textcircled{1} Service: A combination of actions related to data, and it defines the basic operation of a device.
\textcircled{2} Include: Define a relationship between services.
\textcircled{3} Characteristics: A data value used by a service
\textcircled{4} Behavior: A format that may be readable by a computer, which is defined by a Universal Unique Identifier (UUID) and a value type.

The GATT-based profiles are dependent on the GATT and are mainly applied to BLE devices. The GATT-based profiles may include Battery, Time, FindMe, Proximity, Object Delivery Service and so on. More specific descriptions of the GATT-based profiles are as follows.
Battery: A method for exchanging battery information.
Time: A method for exchanging time information.
FindMe: A method for providing an alarm service according to the distance.
Proximity: A method for exchanging battery information.
Time: A method for exchanging time information

The GATT may be used as a protocol by which to describe how the ATT is utilized at the time of composing services. For example, the GATT may be used to define how the ATT profiles are grouped together with services and to describe characteristics associated with the services.

Therefore, the GATT and the ATT describe device statuses and services, and how features are associated with each other and how they are used.

The controller stack includes a physical layer 390, a link layer 380, and a host controller interface 370.

The physical layer 390 (or a wireless transmission and reception module) sends and receives radio signals of 2.4 GHz, and uses GFSK modulation and frequency hopping utilizing 40 RF channels.

The link layer 380 sends or receives Bluetooth packets.

Furthermore, the link layer establishes a connection between devices after performing the advertising and scanning function using three advertising channels, and provides a function of exchanging a maximum of 42 bytes of data packets through 37 data channels.

The host controller interface (HCI) provides an interface between the host stack and the controller stack so that the host stack may provide commands and data to the controller stack and the controller stack may provide events and data to the host stack.

Hereinafter, the procedure of BLE is described briefly.

The BLE procedure includes a device filtering procedure, an advertising procedure, a scanning procedure, a discovering procedure, and a connecting procedure.

### Device Filtering Procedure

The device filtering procedure functions to reduce the number of devices which perform responses to requests, commands, or notification in the controller stack.

All of devices may not need to respond to received requests. Accordingly, the controller stack reduces the number of transmitted requests so that power consumption may be reduced in the BLE controller stack.

An advertising device or a scanning device may perform the device filtering procedure in order to restrict the number of devices which receive advertisement packets, scan requests, or connection requests.

In this case, the advertising device refers to a device which sends an advertisement event, that is, a device which performs advertisement, and is also called an advertiser.

A scanning device refers to a device which performs scanning, that is, a device which sends a scan request.

In the BLE disclosure, if a scanning device receives part of advertisement packets from an advertising device, the scanning device has to send a scan request to the advertising device.

If the transmission of a scan request is not required as the device filtering procedure is used, however, the scanning device may ignore advertisement packets transmitted by an advertising device.

The device filtering procedure may be used even in the connection request procedure. If device filtering is used for the connection request procedure, the need for sending a response to a connection request may be made unnecessary by ignoring the connection request.

### Advertising Procedure

An advertising device performs an advertisement procedure to perform non-directional broadcast using the devices within the range of the advertising device.

In this case, the non-directional broadcast refers to broadcast in all directions rather than broadcast in specific directions.

Unlike the non-directional broadcast, the directional broadcast refers to broadcast in a specific direction. Non-directional broadcast is performed without involving a connection procedure between devices in a listening state (hereinafter referred to as a “listening device”).

The advertising procedure is used to establish a BLE to a nearby initiating device.

In some embodiments, the advertising procedure may be used to provide the periodic broadcast of user data to scanning devices which perform listening through an advertising channel.

In the advertising procedure, all of advertisements (or advertisement events) are broadcasted through an advertising physical channel.

An advertising device may receive a scan request from a listening device which performs a listening operation in order to obtain additional user data from the advertising device. In response to the scan request, the advertising device sends a response to the listening device which has sent the scan request through the same advertising physical channel through which the advertising device has received the scan request.

While broadcast user data sent as part of advertising packets forms dynamic data, scan response data is static for the most part.

An advertising device may receive a connection request from an initiating device through an advertising (or broadcast) physical channel. If the advertising device has used a connectable advertisement event and the initiating device has not been filtered by a filtering procedure, the advertising device stops an advertisement and enters connected mode. The advertising device may resume the advertisement after entering the connected mode.

### Scanning Procedure

A device performing a scan operation, i.e., a scanning device, performs a scanning procedure in order to listen to the non-directional broadcast of user data from advertising devices which use an advertising physical channel.

In order to request additional user data, a scanning device sends a scan request to an advertising device through an advertising physical channel. In response to the scan request, the advertising device includes additional user data requested by the scanning device in a scan response and sends the scan response to the scanning device through the advertising physical channel.

The scanning procedure may be used while a scanning device is connected to another BLE device in a BLE piconet.

If a scanning device receives a broadcast advertising event and stays in initiator mode where a connection request may be initiated, the scanning device may initiate BLE for an advertising device by sending a connection request to the advertising device through an advertising physical channel.

If a scanning device sends a connection request to an advertising device, the scanning device stops the entire scanning for additional broadcast and enters connected mode.

### Discovering Procedure

Devices capable of Bluetooth communication (hereinafter referred to as “Bluetooth devices”) perform an advertising procedure and a scanning procedure in order to discover devices around the Bluetooth devices or devices to be discovered by other devices within a given area.

The discovering procedure is performed in an asymmetric manner. A Bluetooth device searching for another Bluetooth device nearby is called a discovering device, and performs listening in order to search for devices that advertise advertisement events that may be scanned. A Bluetooth device which may be discovered and used by another device is called a discoverable device. A discoverable device actively broadcasts an advertisement event so that other devices may scan the discoverable device through an advertising (or broadcast) physical channel.

Both the discovering device and the discoverable device may already have been connected to other Bluetooth devices in a piconet.

### Connecting Procedure

A connecting procedure is asymmetric. In the connecting procedure, while a particular Bluetooth device performs an advertising procedure, other Bluetooth devices need to perform a scanning procedure.

In other words, the advertising procedure may be a primary task to be performed, and as a result, only one device may respond to an advertisement. After receiving a connectable advertisement event from an advertising device, the connecting procedure may be initiated by sending a connection request to the advertising device through an advertising (or broadcast) physical channel.

Operation statuses defined in the BLE technology, that is, an advertising state, a scanning state, an initiating state, and a connection state, are described briefly below.

### Advertising State

The link layer (LL) enters the advertising state in a command from a host (or stack). If the link layer is in the advertising state, the link layer sends advertising packet data units (PDUs) at advertisement events.

Each advertisement event includes at least one advertising PDU, and the advertising PDU is transmitted through an advertising channel index. Each advertisement event may be previously closed if the advertising PDU is transmitted through each advertising channel index, the advertising PDU is terminated, or the advertising device needs to secure the space in order to perform other functions.

### Scanning State

The link layer enters the scanning state in response to a command from a host (or stack). In the scanning state, the link layer listens to advertising channel indices.

The scanning state supports two types: passive and active scanning. The host determines a scanning type.

No separate time or advertising channel index is defined to perform scanning.

In the scanning state, the link layer listens to an advertising channel index for “scanWindow” duration. scanInterval is defined as the interval between the start points of two consecutive scan windows.

If there is no scheduling collision, the link layer has to perform listening in order to complete all of the scanIntervals of scanWindows as commanded by the host. In each scanWindow, the link layer has to scan other advertising channel indices. The link layer uses all of available advertising channel indices.

In the case of passive scanning, the link layer is unable to send any packet, but only receives packets.

In the case of active scanning, the link layer performs listening to the advertising device to rely on the advertising PDU type by which additional information related to the advertising PDUs and advertising device may be requested.

### Initiating State

The link layer enters the initiating state in response to a command from a host (or stack).

In the initiating state, the link layer performs listening to advertising channel indices.

In the initiating state, the link layer listens to an advertising channel index for “scanWindow” duration.

### Connection State

The link layer enters a connection state when the device performing the connection request, i.e., the initiating device transmits CONNECT_REQ PDU to the advertising device or when the advertising device receives CONNECT_REQ PDU from the initiating device.

After entering the connections state, it is considered that the connection is created. However, it need not be considered so that the connection is established at the time of entering the connections state. An only difference between a newly created connection and the previously established connection is a link layer connection supervision timeout value.

When two devices are connected to each other, two devices play difference roles.

A link layer serving as a master is referred to as the master and a link layer serving as a slave is referred to as the slave. The master controls a timing of a connection event and the connection event refers to a time at which the master and the slave are synchronized.

A packet defined in the Bluetooth interface will be briefly described below. BLE devices use packets defined below.

### Packet Format

The link layer has only one packet format used for both an advertising channel packet and a data channel packet.

Each packet is constituted by four fields, i.e., a preamble, an access address, a PDU, and a CRC.

When one packet is transmitted in an advertising physical channel, the PDU will become an advertising channel PDU and when one packet is transmitted in a data physical channel, the PDU will become a data channel PDU.

### Advertising Channel PDU

The advertising channel PDU includes a 16 bit header and a payload of various sizes.

The PDU type field of an advertising channel included in the header supports PDU types defined in Table 1 below.

TABLE 1

| | | | Permitted PHYs | | |
|---|---|---|---|---|---|
| PDU | | | LE | LE | LE |
| Type | PDU Name | Channel | 1M | 2M | Coded |
| 0000b | ADV_IND | Primary | ◯ | | |
| | | Advertising | | | |
| 0001b | ADV_DIRECT_IND | Primary | ◯ | | |
| | | Advertising | | | |
| 0010b | ADV_NONCONN_IND | Primary | ◯ | | |
| | | Advertising | | | |
| 0011b | SCAN_REQ | Primary | ◯ | | |
| | | Advertising | | | |
| | AUX_SCAN_REQ | Secondary | ◯ | ◯ | ◯ |
| | | Advertising | | | |
| 0100b | SCAN_RSP | Primary | ◯ | | |
| | | Advertising | | | |
| 0101b | CONNECT_IND | Primary | ◯ | | |
| | | Advertising | | | |
| | AUX_CONNECT_REQ | Secondary | ◯ | ◯ | ◯ |
| | | Advertising | | | |
| 0110b | ADV_SCAN_IND | Primary | ◯ | | |
| | | Advertising | | | |

### Advertising PDU

The following advertising channel PDU types are called advertising PDUs and are used for specific events.

ADV_IND: a connectable non-directional advertisement event

ADV_DIREC_IND: a connectable directional advertisement event

ADV_NONCONN_IND: a non-connectable non-directional advertisement event

ADV_SCAN_IND: a non-directional advertisement event that may be scanned

The PDUs are transmitted by the link layer in the advertising state and are received by the link layer in the scanning state or initiating state.

### Scanning PDUs

The advertising channel PDU type below is called a scanning PDU and is used in the status described below.

SCAN_REQ: transmitted by the link layer in the scanning state and received by the link layer in the advertising state.

SCAN_RSP: transmitted by the link layer in the advertising state and received by the link layer in the scanning state.

### Initiating PDUs

The advertising channel PDU type below is called an initiating PDU.

CONNECT_REQ: transmitted by the link layer in the initiating state and received by the link layer in the advertising state.

### Data Channel PDU

The data channel PDU may have a 16-bit header and various sizes of payloads and include a message integrity check (MIC) field.

The procedure, the state, the packet format, and the like in the BLE technology, which are described above, may be applied in order to perform methods proposed by the present disclosure.

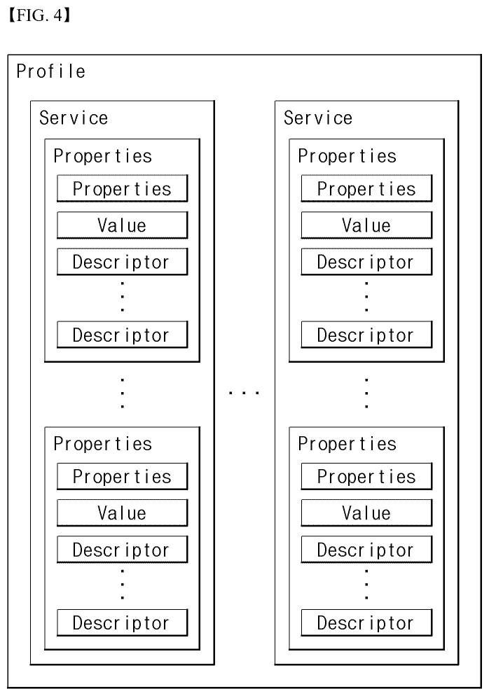

FIG. 4 illustrates an example of a structure of a generic attribute profile (GATT) of Bluetooth low energy.

Referring to FIG. 4, a structure for exchanging profile data of the Bluetooth low energy may be described.

Specifically, the generic attribute profile (GATT) is a definition of a method in which data is transmitted and received by using services and characteristics between the Bluetooth LE devices.

In general, a Peripheral device (e.g., a sensor device) serves as a GATT server and has a definition of services and characteristics.

A GATT client sends a data request to the GATT server in order to read or write the data and all transactions start at the GATT client and the response is received from the GATT server.

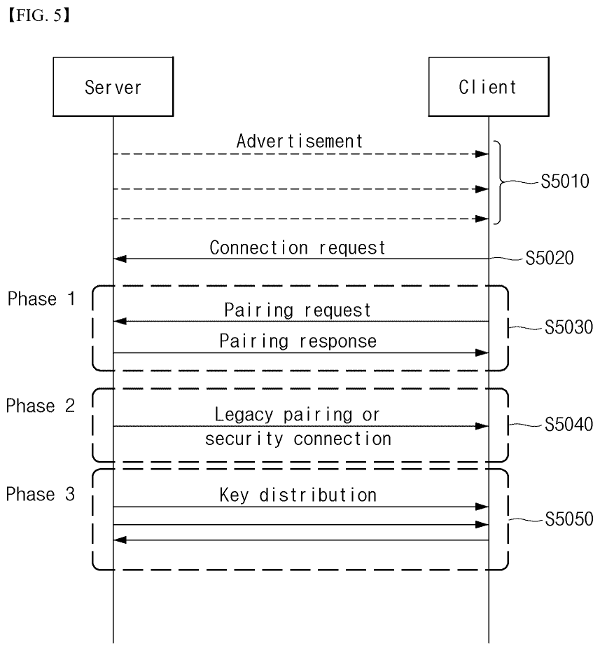

A GATT-based operation structure used in the Bluetooth LE may be based on THE profile, the service, and the characteristic, and may have a vertical structure illustrated in FIG. 5.

The profile may be constituted by one or more services and the service may be constituted by one or more characteristics or other services.

The service may serve to divide data into logical units and include one or more characteristics or other services. Each service has a 16-bit or 128-bit separator called a Universal Unique Identifier (UUID).

The characteristic is a lowest unit in the GATT-based operation structure. The characteristic includes only one datum and has a 16-bit or 128-bit UUID similar to the service.

The characteristic is defined as a value of various information and requires one attribute to contain each information. The characteristic may adopt various consecutive attributes.

The attribute is constituted by four components, which have the following meanings.
handle: Address of attribute
Type: Type of attribute
Value: Value of attribute
Permission: Access authority to attribute

FIG. 5 is a flowchart illustrating an example of a connection procedure method in Bluetooth low power energy technology to which the present disclosure may be applied.

A server transmits to a client an advertisement message through three advertising channels (S5010).

The server may be called an advertiser before connection and called as a master after the connection. As an example of the server, there may be a sensor (temperature sensor, etc.).

Further, the server may be called a scanner before the connection and called as a slave after the connection. As an example of the client, there may be a smartphone, etc.

As described above, in Bluetooth, communication is performed over a total of 40 channels through the 2.4 GHz band. Three channels among 40 channels as the advertising channels are used for exchanging sent and received for establishing the connection, which include various advertising packets.

The remaining 37 channels are used for data exchange after connection to the data channel.

The client may receive the advertisement message and thereafter, transmit the Scan Request message to the server in order to obtain additional data (e.g., a server device name, etc.).

In this case, the server transmits the Scan Response message including the additional data to the client in response to the Scan Request message.

Here, the Scan Request message and the Scan Response message are one type of advertising packet and the advertising packet may include only user data of 31 bytes or less.

Therefore, when there is data in which the size of the data is larger than 3 bytes, but overhead to transmit the data through the connection, the data is divided and sent twice by using the Scan Request message and the Scan Response message.

Next, the client transmits to the server a Connection Request message for establishing a Bluetooth connection with the server (S5020).

Therefore, a Link Layer (LL) connection is established between the server and the client.

Thereafter, the server and the client perform a security establishment procedure.

The security establishment procedure may be interpreted as security simple pairing or may be performed including the same.

That is, the security establishment procedure may be performed through Phase 1 through Phase 3.

Specifically, a pairing procedure (Phase 1) is performed between the server and the client (S5030).

In the pairing procedure, the client transmits a Pairing Request message to the server and the server transmits a Pairing Response message to the client.

Through the pairing procedure, authentication requirements and input (I)/output (O) capabilities and Key Size information are sent and received between the devices. Through the information, which key generation method is to be used in Phase 2 is determined.

Next, as Phase 2, legacy pairing or secure connections are performed between the server and the client (S5040).

In Phase 2, A 128-bit temporary key and a 128-bit short term key (STK) for performing the legacy pairing are generated.
Temporary Key: Key made for creating the STK
Short Term Key (LTK): Key value used for making encrypted connection between devices

When the secure connection is performed in Phase 2, a 128-bit long term key (LTK) is generated.
Long Term Key (LTK): Key value used even in later connection in addition to encrypted connection between the devices

Next, as Phase 3, a Key Distribution procedure is performed between the server and the client (S5050).

Therefore, the secure connection may be established and the data may be transmitted and received by establishing the encrypted link.

### General Matters Related to Isochronous Channel

With respect to an audio signal, audio streaming data or audio data may be periodically generated at an idle event interval.

The audio data is generated periodically (or at a specific time interval) according to a feature thereof. Here, the specific time interval at which the audio data is periodically generated may be expressed as idle event interval. Each audio data is transmitted at each idle event interval. Further, each audio data may be transmitted through an entire interval or a partial interval of the idle event interval. When the audio streaming data which is generated periodically or regularly is transmitted by using a BLE mechanism, an advertising and scanning procedure, a communication procedure, and a disconnection procedure should be performed whenever the generated audio data is transmitted/received. However, the audio data is generally periodically generated, and latency guarantee for audio data transmission is required regardless of a data mount of the audio data.

However, when the advertising and scanning procedure, the communication procedure, and the disconnection procedure should be performed each time newly generated audio data is transmitted, there is a problem in that latency occurs in audio data transmission.

In audio data transmission through hearing aids (HA) or headset, a data generation amount is comparatively small, so when BLE technology is utilized, higher energy efficiency may be obtained than Bluetooth BR/EDR technology, but since a data channel process of the BLE technology should perform advertising, connection, etc., every data transmission as described above, the data transmission has large overhead, and in particular, latency guarantee absolutely required for the audio data transmission may not be guaranteed.

Further, since the data channel process of the BLE technology has a purpose of transmitting isolatedly generated data only as necessary, and inducing deep sleep of a BLE device in other time domains to increase energy efficiency, it may be difficult to apply the data channel process of the BLE technology to transmission of periodically generated audio data.

### Definition of Isochronous Channel and Mechanism Related Thereto

A new channel, i.e., an isochronous channel is defined in order to transmit the periodically generated data by using the BLE technology.

The isochronous channel is a channel used for transmitting the isochronous data between devices (e.g., conductor-member) using an isochronous stream.

The isochronous data refers to data transmitted at a specific time interval, i.e., periodically or regularly.

That is, the isochronous channel may represent a channel in which periodically generated data such as audio data or voice data is transmitted and received in the BLE technology. Further, the isochronous channel may represent a channel on which data generated based on a user input of a game user's controller device is transmitted and received in a gaming scenario. The isochronous channel can be used for transmitting and receiving data to and from a single member, a set of one or more coordinated members, or multiple members. Further, the isochronous channel corresponds to a flushing channel which can be used for transmitting and receiving key data in an isochronous stream such as an audio streaming or other time domains.

### Configuration of Various Embodiments of Present Disclosure

### BACKGROUND OF THE INVENTION

The ULL HID design of ULL Phase 1 was designed using the ISO protocol, which is the Transport, as is. This design proceeded by abandoning protocol optimization in order to publish the specification as quickly as possible. Accordingly, in Phase 2, optimization is planned to be performed by changing the ISO protocol of the Core spec.

### Problems of Prior Art

Existing Phase 1 used the ISO Link layer without changing the Core spec. Although the existing ISO Link layer could implement a latency of 1 ms, efficiency, power saving, and performance of the link layer were not considered. In Phase 2, it is necessary to improve the efficiency, power saving, and performance of the Link layer while maintaining the existing requirement (1 ms latency) by considering these three aspects.

### Improvements of Proposed Technology

1. Modification of the Bluetooth ISO transport protocol for transmitting Input information and Output information of HID devices (Central, Peripheral).
2. A direction to improve Network efficiency, Power saving, and Performance while maintaining the existing requirement (1 ms latency).
(1) A broadcasting method of a Bluetooth Isochronous channel, and (2) a PAwR (Periodic Advertising with Response) method are used as a basic base to design a new protocol.
A. The Central (game console, TV) transmits Periodic Advertising (PA)—The Peripheral (gamepad) catches the PA and synchronizes the timing (Send, Receive time).
B. After the Timing synchronization, the Peripheral (gamepad) sends an Acknowledgment (Ack) signal to the Central indicating that PA is no longer needed (in PAwR or Unicast manner). Periodic transmission of AUX_EXT_IND and AUX_ADV_IND corresponding to the PA is no longer necessary.
C. After being synchronized, the Central transmits information using only AUX_SYNC_IND (or AUX_SYNCSUBEVENT_IND) to align synchronization between the Central and the Peripheral.
D. While the existing ISO Protocol sent a Poll for every Subevent, a group poll is sent by grouping multiple Subevent groups. An Output Report of the game console may be transmitted in the Poll. An Input Report of the Gamepad may be transmitted in the Response. (Unlike the existing PAwR where the Response is a response from each of multiple devices, the changed Response is a response from a single gamepad).
E. When Gamepads of multiple devices are synchronized and connected to one game console, the Response of each device responds in an interleaving manner.
F. Reliability is satisfied by the method used in the existing Phase 1. 1> Simple repetition (simple repetition of the same report) 2> Historic repetition (superimposed repetition of a previous report).

### Effects of Proposed Technology

The Bluetooth protocol can be designed to efficiently transmit Bluetooth HID Input information and Output information.

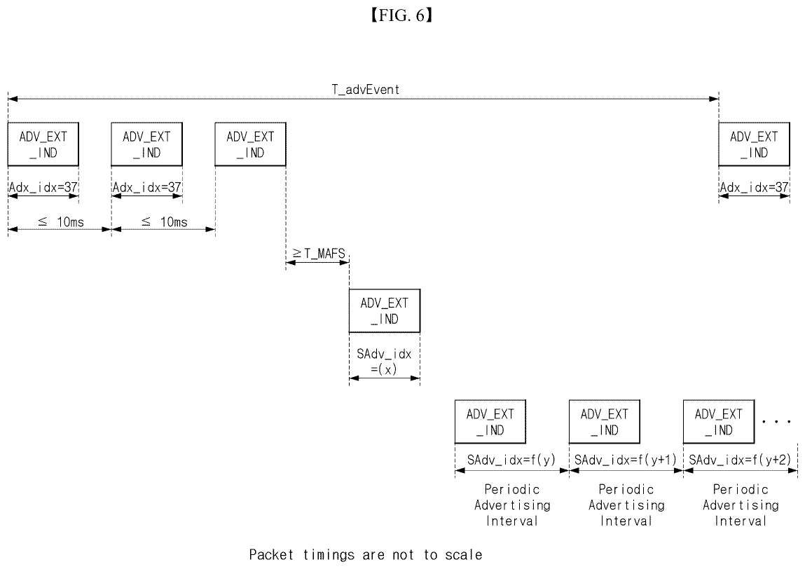

FIG. 6 illustrates an example of a timing relationship in which an ADV_EXT_IND packet, an AUX_ADV_IND packet, and an AUX_SYNC_IND packet are arranged on a Periodic Advertising event and a Periodic Advertising interval.

Referring to FIG. 6, the central device repeatedly initiates an advertising event using an ADV_EXT_IND packet on a primary advertising channel, and T_advEvent at the top of the drawing indicates a time interval between consecutive advertising events. Each ADV_EXT_IND packet may be scheduled such that an interval to an adjacent next ADV_EXT_IND packet is 10 milliseconds or less, and an advertising index (Adv_idx) is incremented for each ADV_EXT_IND packet so that, for example, Adv_idx of a first ADV_EXT_IND packet may be assigned as 37, and Adv_idx of a next ADV_EXT_IND packet may be assigned as 38.

After the ADV_EXT_IND sequence, an AUX_ADV_IND packet is transmitted on a secondary advertising channel, and the AUX_ADV_IND packet is a packet indicating a start of a Periodic Advertising set and may include a sub-advertising index (SAdv_idx) together with PAwR related parameters. In the example of FIG. 6, SAdv_idx assigned to the AUX_ADV_IND packet is shown as x, and this AUX_ADV_IND packet may be configured to be transmitted after a predetermined minimum interval T_MAFS or more has elapsed from the immediately preceding transmitted ADV_EXT_IND packet.

As shown at the bottom of FIG. 6, an AUX_SYNC_IND packet is transmitted once per Periodic Advertising interval, and each AUX_SYNC_IND packet includes a sub-advertising index (SAdv_idx) for identifying a Subevent used in the corresponding Periodic Advertising interval. For example, SAdv_idx of a first AUX_SYNC_IND packet may be assigned as f (y), SAdv_idx of a second AUX_SYNC_IND packet as f (y+1), and SAdv_idx of a third AUX_SYNC_IND packet as f (y+2) according to a constant function relationship according to an order of the Periodic Advertising interval, where f may be a design function for mapping a Subevent number within a PAwR event and a Periodic Advertising Subevent.

According to such a structure of FIG. 6, the central device provides basic synchronization information for Periodic Advertising to a new peripheral device using ADV_EXT_IND and AUX_ADV_IND packets, and thereafter, by transmitting only an AUX_SYNC_IND packet for each Periodic Advertising interval, it is possible to efficiently update PAwR Subevent schedule information for an already synchronized peripheral device while reducing overall advertising overhead.

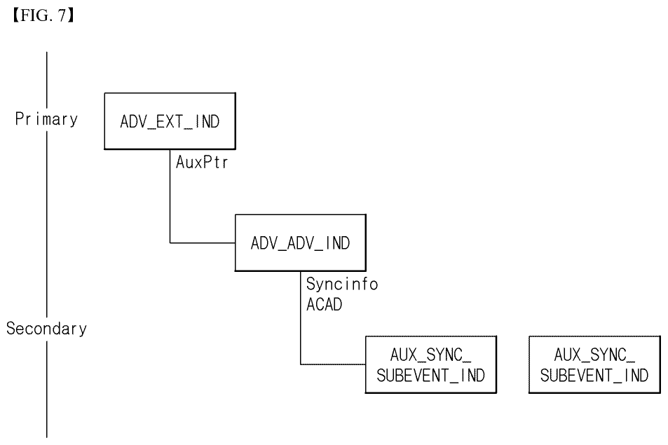

FIG. 7 illustrates an example of a packet connection structure of a Periodic Advertising chain consisting of ADV_EXT_IND, AUX_ADV_IND, and AUX_SYNC_SUBEVENT_IND.

Referring to FIG. 7, an extended advertising packet, ADV_EXT_IND, is transmitted on the Primary axis at the top, and the ADV_EXT_IND may be configured to point to an auxiliary advertising packet transmitted on the Secondary axis at the bottom through an AuxPtr field.

On the Secondary axis, an ADV_ADV_IND packet referenced by the AuxPtr of the ADV_EXT_IND is transmitted first, and this ADV_ADV_IND packet may include a SyncInfo field for Periodic Advertising and PAwR operations and an ACAD field which is common additional advertising data, thereby providing information related to Subevents for subsequent AUX_SYNC_SUBEVENT_IND packets.

After the ADV_ADV_IND, one or more AUX_SYNC_SUBEVENT_IND packets may be continuously transmitted, and each AUX_SYNC_SUBEVENT_IND packet includes parameters such as a Periodic Advertising Subevent identifier, a number of response slots, a Subevent interval, a response slot delay, and a response slot spacing, so that a receiving device can determine a timing and a structure to respond in a specific PAwR Subevent.

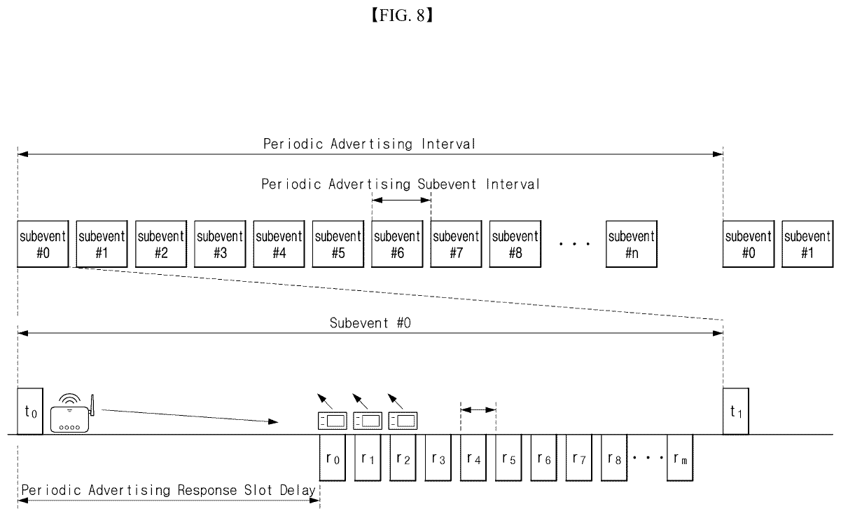

FIG. 8 illustrates an example of a structure in which a plurality of response slots are arranged according to a plurality of Subevents, Periodic Advertising response slot delay, and response slot spacing within a Periodic Advertising interval.

Referring to FIG. 8, one Periodic Advertising Interval is shown at the top, and Subevents #0, #1, #2, . . . , #n may be sequentially arranged according to a Periodic Advertising Subevent Interval indicating an interval between Subevents within this Periodic Advertising Interval.

In the example of FIG. 8, a section of Subevent #0 is highlighted, and a plurality of response slots r0, r1, r2, . . . , rm are sequentially arranged from a time point when a predetermined Periodic Advertising Response Slot Delay has elapsed since a start time to of this Subevent #0 section. An interval between each response slot may be defined by a Periodic Advertising Response Slot Spacing, and the central device may schedule to receive responses from peripheral devices for these response slots within the Subevent #0 section.

As shown at the bottom of FIG. 8, when the central device broadcasts PAwR advertising or synchronization information (Sync info) in Subevent #0, a plurality of peripheral devices (e.g., gamepads, headsets, etc. indicated in different colors) may transmit response packets corresponding to response slots r0, r1, r2, etc. assigned to them, respectively. Accordingly, since multiple peripheral devices can respond to one Subevent and one synchronization information without collision, uplink data for a plurality of peripheral devices can be efficiently collected within the same Periodic Advertising Interval.

Also, on the right side of FIG. 8, Subevent #0 and Subevent #1 are shown again as a part of a next Periodic Advertising Interval, indicating that the Subevent and response slot configuration of the same structure can be periodically reused as the Periodic Advertising Interval is repeated. Through this structure, the central device can appropriately set Subevent and response slot parameters (numSubEvents, subeventInterval, responseSlotDelay, responseSlotSpacing, etc.) in a PAwR-based bidirectional communication environment, thereby flexibly adjusting the number of peripheral devices and response frequency according to system requirements.

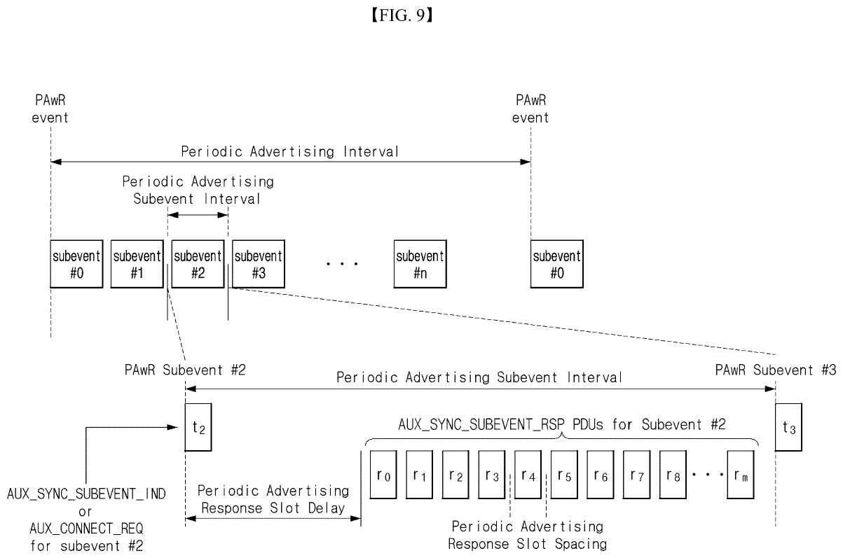

FIG. 9 illustrates an example of a timing relationship in which AUX_SYNC_SUBEVENT_IND or AUX_CONNECT_REQ is transmitted for a specific Subevent selected in a PAwR event, and AUX_SYNC_SUBEVENT_RSP PDUs corresponding thereto are arranged in Periodic Advertising response slots.

Referring to FIG. 9, at the top, an example is shown in which Subevents #0, #1, #2, #3, and #n are arranged according to a periodic advertising subevent interval within one PAwR event, and a structure in which such PAwR events are repeated during a periodic advertising interval is shown. The central device may select, for example, Subevent #2 from among the plurality of Subevents, and transmit, in a broadcast manner, an AUX_SYNC_SUBEVENT_IND packet including synchronization information for the selected Subevent or an AUX_CONNECT_REQ packet for establishing a connection with a specific peripheral device in synchronization with a time when the corresponding Subevent starts.

At the bottom, a timing structure of a PAwR sub event #2 corresponding to the selected Subevent #2 is shown in an enlarged manner, wherein time t2 indicates a start time of Subevent #2, and time t3 indicates a start time of a next Subevent #3. After the start of Subevent #2, a plurality of response slots denoted by r0, r1, r2, . . . , rn are sequentially arranged according to a Periodic Advertising Response Slot Spacing after a predetermined Periodic Advertising Response Slot Delay has elapsed. Each peripheral device may provide a response to the AUX_SYNC_SUBEVENT_IND by transmitting an AUX_SYNC_SUBEVENT_RSP packet in a response slot assigned to it, or when AUX_CONNECT_REQ is used, transmit a response packet including information necessary for connection establishment.

Therefore, according to the structure of FIG. 9, the central device selects a specific Subevent within a PAwR event to perform a polling role for a plurality of peripheral devices through AUX_SYNC_SUBEVENT_IND or AUX_CONNECT_REQ, and receives AUX_SYNC_SUBEVENT_RSP packets in response slots associated with the same Subevent, thereby efficiently collecting uplink data from peripheral devices and simultaneously supporting connection with a specific peripheral device if necessary.

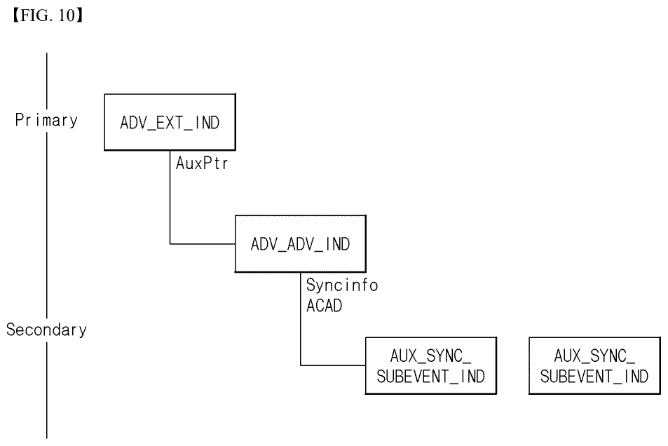

FIG. 10 illustrates another example of a Periodic Advertising structure in which ADV_EXT_IND of a primary advertising channel and AUX_ADV_IND and AUX_SYNC_SUBEVENT_IND of a secondary advertising channel are continuously transmitted.

Referring to FIG. 10, an extended advertising packet, ADV_EXT_IND, is transmitted on the Primary axis at the top, and the ADV_EXT_IND may be configured to point to an auxiliary advertising packet transmitted on the Secondary axis at the bottom through an AuxPtr field. The ADV_EXT_IND is an extended advertising packet that a peripheral device receives through scanning, and indirectly provides timing information and a secondary advertising channel where subsequent ADV_ADV_IND and AUX_SYNC_SUBEVENT_IND packets are located.

On the Secondary axis, an ADV_ADV_IND packet referenced by the AuxPtr of the ADV_EXT_IND is transmitted, and this ADV_ADV_IND packet may include basic timing parameters of Periodic Advertising, for example, a Periodic Advertising Interval, a number of Subevents, and a Subevent interval through a SyncInfo field, and provide common additional advertising data related to PAwR operation through an ACAD field. By continuously receiving ADV_EXT_IND and ADV_ADV_IND, the peripheral device can predict the structure of a PAwR advertising set and a location of a Subevent where AUX_SYNC_SUBEVENT_IND will be transmitted in the future.

After the ADV_ADV_IND, one or more AUX_SYNC_SUBEVENT_IND packets may be continuously transmitted, and each AUX_SYNC_SUBEVENT_IND packet includes synchronization information and response slot parameters corresponding to a specific Subevent, thereby defining at which point the peripheral device should respond in the corresponding Subevent. For example, the AUX_SYNC_SUBEVENT_IND may include a Subevent identifier, a number of response slots, a response slot delay, and a response slot spacing, and using this information, the peripheral device can transmit uplink data in a response slot assigned to it after completing synchronization to the PA packet.

Therefore, according to the structure shown in FIG. 10, the peripheral device can be synchronized to PAwR-based Periodic Advertising simply by scanning ADV_EXT_IND and ADV_ADV_IND and then interpreting the received AUX_SYNC_SUBEVENT_IND without performing a separate connection establishment procedure or PAST procedure, so that a plurality of peripheral devices can be efficiently synchronized and managed in a low-power environment.

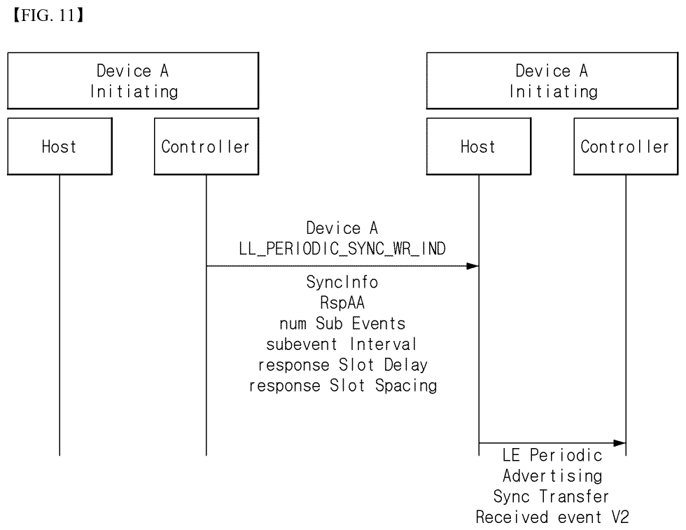

FIG. 11 illustrates an example of a PAST (Periodic Advertising Sync Transfer) procedure for transmitting Periodic Advertising synchronization information and PAwR related parameters from Device A to Device B through an LE-ACL connection.

Referring to FIG. 11, Device A transmitting Periodic Advertising (PA) synchronization information is shown on the left, and Device B receiving the synchronization information is shown on the right. Device A and Device B are connected via an LE-ACL connection, and a controller of Device A may transmit an LL_PERIODIC_SYNC_WR_IND control message to a controller of Device B on the LE-ACL connection. The LL_PERIODIC_SYNC_WR_IND message may include PAwR related parameters such as a Response Access Address (RspAA), a number of Subevents (numSubEvents), a Subevent interval (subeventInterval), a response slot delay (responseSlotDelay), and a response slot spacing (responseSlotSpacing) in addition to SyncInfo which is basic Periodic Advertising (PA) synchronization information.

After receiving the LL_PERIODIC_SYNC_WR_IND message, the controller of Device B may store the SyncInfo and PAwR parameters included therein, and generate an LE Periodic Advertising Sync Transfer Received event to an upper host, thereby notifying that the Periodic Advertising (PA) synchronization information has been normally delivered. The host of Device B may configure a local schedule for PAwR Subevents and response slots based on the RspAA, num SubEvents, subeventInterval, responseSlotDelay, and responseSlotSpacing values included in the event, and thereafter determine at which point and using which response slot to respond to the central device for each Subevent according to the corresponding parameters.

Such a PAST procedure is a method that allows a peripheral device to collectively receive necessary Periodic Advertising (PA) synchronization information and PAwR parameters through an already established LE-ACL connection, instead of directly scanning an extended advertising packet such as ADV_EXT_IND. The method of scanning the advertising packet has an advantage that a separate connection establishment is not required, but has a disadvantage that power consumption increases because the peripheral device must perform continuous scanning so as not to miss the advertising packet. On the other hand, in the PAST-based method shown in FIG. 11, since the peripheral device receives SyncInfo and PAwR parameters through the LE-ACL connection when necessary while performing only normal Bluetooth Low Energy advertising reception, a structure suitable for a peripheral device operating with limited power can be provided.

Meanwhile, from the perspective of Device A which is an advertising transmitter, if PAwR advertising is operated while repeatedly transmitting the extended advertising packet ADV_EXT_IND, radio resource scheduling may become complex. Therefore, in some embodiments, the advertising transmitter may be configured to omit ADV_EXT_IND transmission and periodically transmit only AUX_SYNC_SUBEVENT_IND which is a packet dedicated to PAwR, and in this case, since the peripheral device cannot acquire PAwR parameters only by ADV_EXT_IND scanning, the PAST procedure as shown in FIG. 11 may be used as virtually the only synchronization means. That is, in this embodiment, the PAST procedure performs a function of allowing accurate synchronization to the Periodic Advertising (PA) Subevent and response slot structure even without ADV_EXT_IND scanning, by transmitting the entire PAwR related parameters to another device using the LE-ACL connection.

Next, parameters and an operation structure of PAwR (Periodic Advertising with Responses) will be described in more detail.

In the conventional Periodic Advertising (PA) method, only basic timing information such as a Periodic Advertising interval and a synchronization packet window offset was included in the SyncInfo field. In contrast, in PAwR, Additional Controller Advertising Data (ACAD) exchanged exclusively for PAwR may be used in addition to such SyncInfo. The ACAD may include parameters such as, for example, a Response Access Address, a number of Subevents, a Subevent Interval, a Response Slot Delay, and a Response Slot Spacing, and the central device and the peripheral device may form a common time axis for the same PAwR event structure using these parameters.

The Periodic Advertising Interval may have the same range as that used in conventional Periodic Advertising (PA). For example, the Periodic Advertising Interval value may be set in a range of 7.5 milliseconds or more and 81.91875 seconds or less, and at this time, each value may be quantized to a value obtained by multiplying 1.25 milliseconds by an integer coefficient. In other words, the Periodic Advertising Interval may be set to one of a plurality of candidate values increasing in units of 1.25 milliseconds, so that a long period or a short period can be flexibly selected according to system requirements.

In PAwR, a concept of a plurality of Subevents is introduced within such a Periodic Advertising Interval. The number of Subevents may be set, for example, in a range of 1 or more and 128 or less, and the Subevent interval may be set to one of values increasing in units of 1.25 milliseconds in a range of 7.5 milliseconds or more and 318.75 milliseconds or less. The central device may combine the number of Subevents and the Subevent interval to schedule the Subevents to be arranged without interference with each other within one Periodic Advertising Interval. The peripheral device may calculate an expected start time of each Subevent by interpreting information related to the Subevent included in SyncInfo and ACAD, and select a Subevent it needs to receive or transmit.

Within each Subevent, the central device, which is a broadcaster, has a transmission slot for transmitting one packet. For example, the central device may transmit a packet such as AUX_SYNC_SUBEVENT_IND at a start time of a Subevent to provide synchronization and polling information for the corresponding Subevent to the peripheral device. Thereafter, after a predetermined delay time (response slot delay) has elapsed from the start of the Subevent, a plurality of Response Slots may be defined. The number of response slots may be selected, for example, from 0 or more and 255 or less, and the response slot delay value may be set to one of values increasing in units of 1.25 milliseconds in a range of 1.25 milliseconds or more and 317.5 milliseconds or less. The response slot spacing value may be set to one of values increasing in units of 0.125 milliseconds in a range of 0.25 milliseconds or more and 31.875 milliseconds or less, and an interval between two adjacent response slots may be determined according to this value.

According to the parameters defined as above, within one Subevent, a structure is formed in which the central device transmits a broadcast packet first, and then a plurality of response slots are arranged at regular intervals. The peripheral device may calculate an index of a response slot assigned to itself using information on the response slot delay, the response slot spacing, and the number of response slots included in ACAD, and perform bidirectional communication with the central device by transmitting a response packet such as AUX_SYNC_SUBEVENT_RSP in the corresponding slot. When the number of Subevents is large and the number of response slots is sufficiently secured, multiple peripheral devices may be mapped to different Subevents and different response slots within one Periodic Advertising Interval, so that uplink data can be transmitted without collision.

In addition, a method for the peripheral device to acquire PAwR parameters can be largely divided into two types. The first method is a method in which the peripheral device acts as a scanner and directly receives SyncInfo and ACAD while continuously scanning the extended advertising packet ADV_EXT_IND. This method has a simple structure because it operates without connection establishment with the central device, but has a disadvantage that battery consumption increases because the peripheral device must maintain a scanning state for a long time so as not to miss the advertising packet. The second method is a method in which the peripheral device receives PAwR related timing information through a PAST (Periodic Advertising Sync Transfer) procedure after establishing a Bluetooth Low Energy connection with the central device. In this case, since the peripheral device performs only general advertising channel scanning and can receive necessary parameters at once after the connection is established, it is advantageous in terms of power consumption. However, since the central device transmitting the advertising must perform both Periodic Advertising (PA) scheduling and connection maintenance, radio resource management may become relatively complex.

In some embodiments, the advertising transmitter may be configured to minimize ADV_EXT_IND transmission and periodically transmit only packets dedicated to PAwR such as AUX_SYNC_SUBEVENT_IND in order to reduce the burden of the scanning method based on ADV_EXT_IND. In this case, the PAST procedure becomes virtually the only synchronization means to deliver PAwR parameters to the peripheral device, and the advertising transmitter delivers necessary SyncInfo and ACAD to a selective peripheral device through PAST, thereby supporting even a low-power peripheral device that does not perform scanning to be accurately synchronized to the PAwR structure.

By using the PAwR parameter structure and synchronization procedure as described above, the central device can configure a Periodic Advertising chain as shown in FIGS. 6 to 11, and appropriately design each Subevent and response slot to efficiently collect responses from a plurality of peripheral devices. Furthermore, as in an embodiment of the present invention, by combining such a PAwR-based Subevent structure with upper layer protocols such as a group polling method associated with an Isochronous Interval, interleaving response of a plurality of devices, and Simple repetition and Historic repetition of an Input Report, low-latency and high-reliability input transmission between the central device and the peripheral device becomes possible.

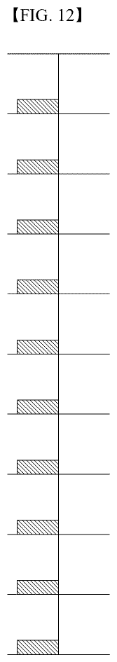

FIG. 12 illustrates an example of a broadcast isochronous stream in which a plurality of sub-intervals are arranged at equal intervals within an Isochronous Interval (ISO Interval).

Referring to FIG. 12, the illustrated timing diagram schematically shows an example in which a plurality of sub-intervals are arranged at equal intervals within one ISO Interval in a broadcast isochronous stream. In the figure, for convenience of explanation, advertising packets such as ADV_EXT_IND, AUX_ADV_IND, and AUX_SYNC_IND are omitted, and only a structure in which a broadcast isochronous Subevent is transmitted once in each sub-interval is simplified and displayed. Each vertical line represents a reference time point within the ISO Interval, and a rectangular block adjacent to each vertical line represents a broadcast isochronous Subevent transmitted at the corresponding time point.

In this embodiment, it is shown that one ISO Interval is subdivided into a plurality of sub-intervals, and a packet including a payload of the broadcast isochronous stream is transmitted in each sub-interval. For example, based on an ISO Interval length and a BN value among ISO link parameters, a case where one ISO Interval is 10 ms and the number of sub-intervals per one ISO Interval, that is, the BN value is 10, can be considered. In this case, one ISO Interval consists of 10 sub-intervals of the same length, and one broadcast isochronous Subevent is arranged for each sub-interval, so that a continuous broadcast isochronous stream can be formed.

ISO link parameters defined in the Core Specification, for example, the ISO Interval length and sub-interval related parameters that may be included in a BIGInfo field of AUX_SYNC_IND, may stipulate to control the sub-interval spacing only with a time resolution of a specific integer multiple unit at a link level, and may not necessarily guarantee a perfectly equal interval in an ideal sense as shown in FIG. 12. However, in some embodiments, a link controller of the central device may operate to schedule sub-intervals as equally spaced as possible based on the parameters, and accordingly, the peripheral device can stably receive the broadcast isochronous Subevent in accordance with the sub-interval timing that occurs repeatedly within one ISO Interval. Meanwhile, in such a broadcast isochronous method, unidirectional data is transmitted from the central device to the peripheral device, and a configuration may be taken in which a function of transmitting reverse direction isochronous data from the peripheral device to the central device is not provided.

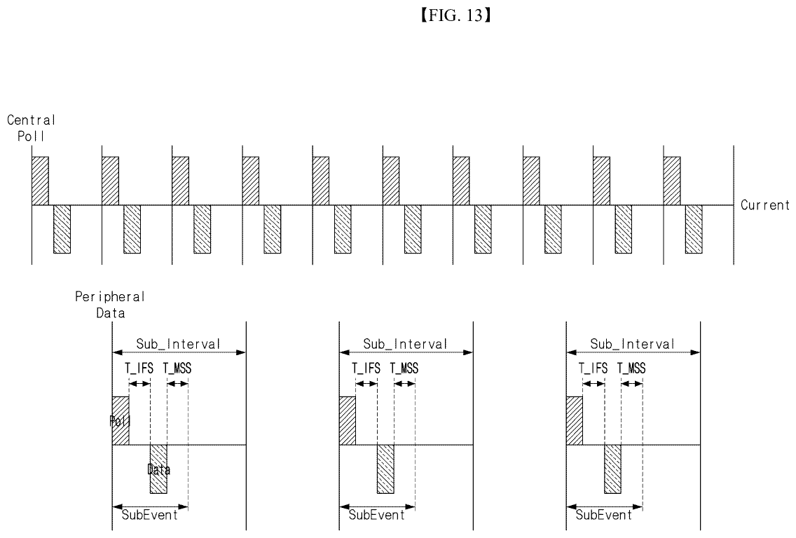

FIG. 13 illustrates an example of a conventional polling method in which a poll packet of a central device and a data packet of a peripheral device are exchanged on a one-to-one basis in each sub-interval in a unicast isochronous link.

As shown in FIG. 13, a unicast isochronous link has a structure in which a central device transmits a poll packet at each start time of each sub-interval (Sub_Interval), and a peripheral device transmits a data packet in response thereto. At the top of the drawing, a Central Poll is repeatedly arranged along a time axis, wherein the central device transmits a poll packet first in each sub-interval, and an Input Report data packet of the peripheral device is transmitted in response to the corresponding poll in a Peripheral Data area shown at the bottom of the drawing. An enlarged view at the bottom shows a structure in which the poll packet and the data packet are exchanged with a predetermined time interval within the sub-interval, and T_IFS indicating an interval for a predetermined time after the end of the poll packet and T_MSS corresponding to a margin time secured between the poll packet and the data packet are displayed, and it shows that a Subevent including these sections is arranged within one sub-interval.

In the current unicast isochronous method, since the central device must transmit a poll packet in every sub-interval to collect data of the peripheral device, a transmission/reception operation for performing a poll is always required on the central device side, and as a result, there is a problem that power consumption increases and link management becomes complicated. FIG. 13 is based on sub-interval timing originally defined in a Bluetooth isochronous channel, but simplifies and shows only exchange timing of the Central Poll and the Peripheral Data for convenience of explanation, and visually shows that when a minimum constraint time of T_IFS and T_MSS decreases due to introduction of a frame spacing technology, a time ratio occupied by an actual Subevent in one sub-interval may be further reduced.

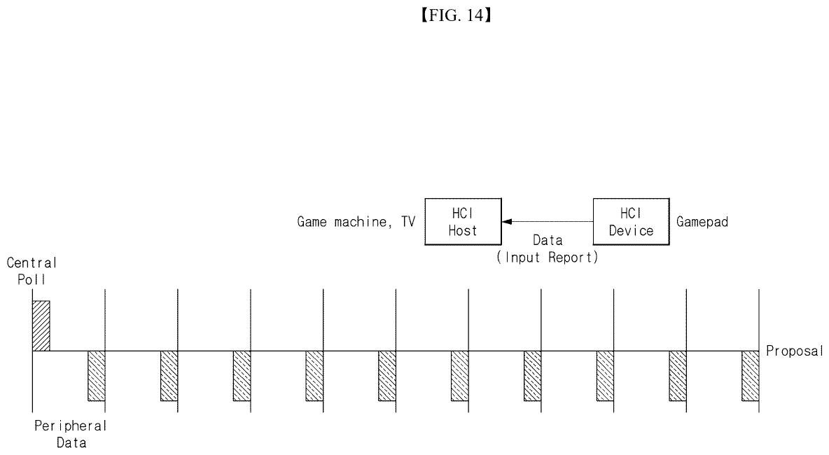

FIG. 14 illustrates an example of a group polling method (proposed method) in which an Input Report of a peripheral device is transmitted in a plurality of sub-intervals in response to a single poll performed at the beginning of one Isochronous Interval (ISO Interval).

Referring to FIG. 14, a group polling structure is shown in which a central device transmits a single poll packet at the beginning of one ISO Interval, and in response to the single poll packet, Input Report packets of a peripheral device are sequentially transmitted in each of a plurality of sub-intervals arranged within the same ISO Interval. Here, the central device may correspond to an HCI host such as a game console or a television, and the peripheral device may correspond to an HCI device such as a gamepad, and the HCI device generates its own HID Input Report for each sub-interval and transmits it to the HCI host. At this time, since the Central Poll is performed only in units of ISO Interval and the Peripheral Data is transmitted in units of sub-interval, there is no need to transmit a poll packet for every sub-interval as in the conventional unicast isochronous method, and accordingly, radio resource consumption and battery consumption on the central side are reduced, and management for collectively collecting input traffic for a plurality of peripheral devices can be simplified.

Also, as in the example of FIG. 14, the group polling method of the present invention may apply a reliability option defined in an ultra-low latency isochronous transmission standard. For example, in a Simple repetition mode, one same Input Report is redundantly included in a plurality of service data units and transmitted multiple times in different sub-intervals, so that even if packet loss occurs in a specific sub-interval, data loss can be compensated for using a report received in another sub-interval. As another example, in a Historic repetition mode, a current Input Report and one or more previous Input Reports are included together in one service data unit and transmitted, so that a continuous sequence of Input Reports can be restored without a retransmission procedure in an upper layer, thereby further improving reliability of Input Report collection according to the group polling method even in a packet error environment.

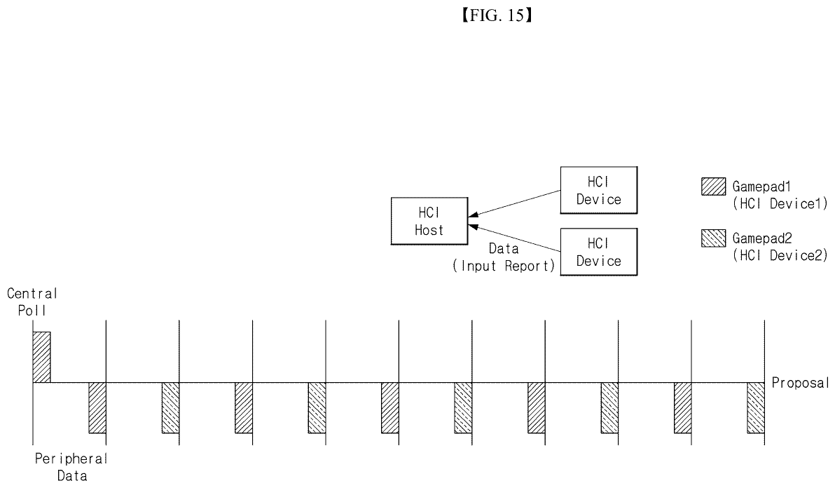

FIG. 15 illustrates an example of a group polling operation in which a plurality of gamepads (HID devices) transmit Input Reports in an interleaving manner for each sub-interval in response to a single poll in one Isochronous Interval (ISO Interval).

Referring to FIG. 15, a group polling operation is shown in which a central device transmits a single poll packet at a starting time point of one ISO Interval, and in response thereto, a plurality of HID devices, for example, Gamepad 1 and Gamepad 2, transmit Input Report data through response slots alternately allocated in each sub-interval within the same ISO Interval.

In FIG. 15, each sub-interval is arranged in an interleaving manner to correspond to a specific HID device, and the central device can sequentially collect Input Reports of a plurality of HID devices in consecutive sub-intervals with only one poll packet. The block diagram at the top schematically shows a logical configuration in which an Input Report of each gamepad is delivered to an HCI host according to such a group polling method between the HCI host of a host device such as a game console or a television and a plurality of gamepad HCI devices.

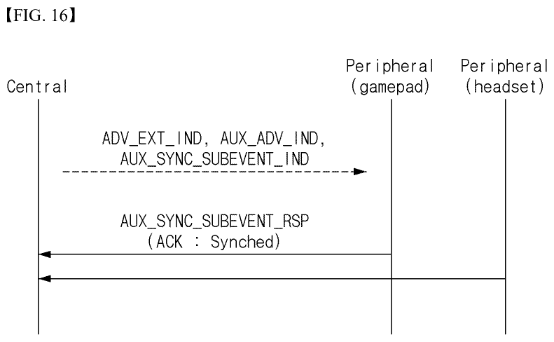

FIG. 16 illustrates an example of a procedure in which a central device transmits a Periodic Advertising (PA) packet including ADV_EXT_IND, AUX_ADV_IND, AUX_SYNC_SUBEVENT_IND, etc., and peripheral devices such as a gamepad and a headset transmit AUX_SYNC_SUBEVENT_RSP as an Acknowledgment (Ack) signal to notify completion of PA synchronization.

As shown in FIG. 16, the central device (e.g., a game console or a television) transmits one or more PA packets including ADV_EXT_IND, AUX_ADV_IND, and AUX_SYNC_SUBEVENT_IND in a broadcast manner in an introduction part for Periodic Advertising synchronization, and one or more peripheral devices such as a gamepad and a headset extract synchronization information regarding a Periodic Advertising interval, a number of Subevents, a Subevent interval, a response slot delay, and a response slot spacing from the received PA packets to be synchronized to the timing of the central device, and then transmit AUX_SYNC_SUBEVENT_RSP to the central device as an Acknowledgment (Ack) signal indicating that they are normally synchronized to the PA timing. At this time, the central device recognizes that the corresponding peripheral device is synchronized to a state capable of data transmission/reception in a PA-based communication section by receiving the AUX_SYNC_SUBEVENT_RSP from each peripheral device, and by increasing a transmission period of PA introduction packets including ADV_EXT_IND and AUX_ADV_IND, which were repeatedly transmitted only for Periodic Advertising synchronization, or by discontinuing the transmission itself, a time ratio consumed for PA synchronization in the total bandwidth can be reduced and effective resources usable for broadcast or unicast data transmission can be expanded.

### [Description Related to Central Device Claim]

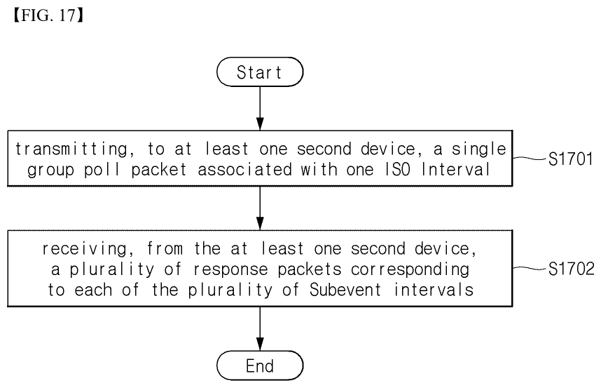

Hereinafter, the above-described embodiments will be described in detail with reference to FIG. 17 in terms of the operation of a UE. Methods to be described below are just distinguished for convenience and unless the methods mutually exclusive, it is needless to say that some components of any one method may be substituted with some components of another method or may be applied in combination with each other.

FIG. 17 illustrates an example of an operation process of a wireless device in the short-range wireless communication system according to various embodiments of the present disclosure.

According to various embodiments of the present disclosure, a method performed by a wireless device (i.e., a first device) in a short-range wireless communication system is provided.

The first device includes: a first processor corresponding to a host stack; a second processor corresponding to a first controller stack; a memory; and a transceiver. The host stack and the controller stack are connected by a Host Controller Interface (HCI).

In step S1701, the first device transmits, to at least one second device, a single group poll packet associated with one Isochronous Interval (ISO Interval), wherein the ISO Interval comprises a plurality of Subevent intervals.

In step S1702, the first device, in response to the single group poll packet, receives, from the at least one second device, a plurality of response packets corresponding to each of the plurality of Subevent intervals, wherein the group poll packet operates as a single poll for an entirety of the plurality of Subevent intervals.

According to various embodiments of the present disclosure, the group poll packet comprises an Output Report of the first device.

According to various embodiments of the present disclosure, the Output Report comprises information for vibration of the at least one second device. The group poll packet is transmitted including the Output Report once per a plurality of ISO Intervals.

According to various embodiments of the present disclosure, the plurality of response packets comprise an Input Report of the at least one second device.

According to various embodiments of the present disclosure, the Input Report comprises a Simple repetition of a same report or a Historic repetition of a previous report for ensuring reliability.

According to various embodiments of the present disclosure, when the at least one second device is a plurality of second devices, the plurality of response packets are received from the plurality of second devices in an interleaving manner.

According to various embodiments of the present disclosure, the embodiments of FIG. 17 further comprise: transmitting, to the at least one second device, a Periodic Advertising (PA) packet; receiving, from the at least one second device, an Acknowledgment (Ack) signal indicating that synchronization to the PA packet is completed; and in response to the Ack signal, discontinuing transmission of at least a part of the PA packet (AUX_EXT_IND or AUX_ADV_IND).

According to various embodiments of the present disclosure, a wireless device is provided in a short-range wireless communication system. The wireless device includes: a first processor corresponding to a host stack; a second processor corresponding to a first controller stack; a memory; and a transceiver. The host stack and the controller stack are connected by a Host Controller Interface (HCI). The memory may be configured to store instructions for performing the operation method of the first device according to FIG. 17 based on being executed by the first processor and the second processor.

According to various embodiments of the present disclosure, a control device controlling the wireless device is provided in the short-range wireless communication system. The control device includes at least one processor; and at one memory operably accessing the at least one processor. The at least one memory may be configured to store instructions for performing the operation method of the first device according to FIG. 17 based on being executed by the at least one processor.

According to various embodiments of the present disclosure, provided are one or more non-transitory computer readable media (CRM) storing one or more instructions. The one or more instructions may perform operations based on being executed by one or more processors, and the operations may include the operation method of the first device according to FIG. 17.

### [Description Related to Peripheral Device Claim]

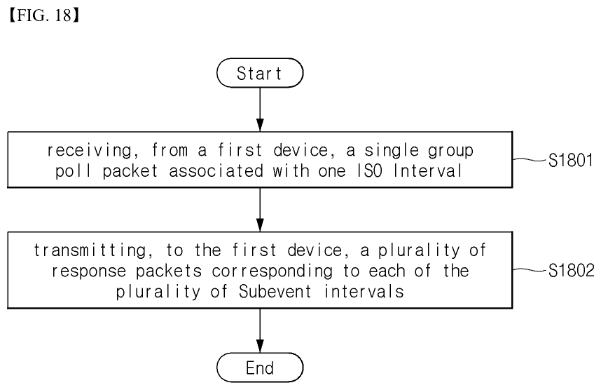

Hereinafter, the above-described embodiments will be described in detail with reference to FIG. 18 in terms of the operation of a UE. Methods to be described below are just distinguished for convenience and unless the methods mutually exclusive, it is needless to say that some components of any one method may be substituted with some components of another method or may be applied in combination with each other.

FIG. 18 illustrates an example of an operation process of a wireless device in the short-range wireless communication system according to various embodiments of the present disclosure.

According to various embodiments of the present disclosure, a method performed by a wireless device (i.e., a second device) in a short-range wireless communication system is provided.

The second device includes: a first processor corresponding to a host stack; a second processor corresponding to a second controller stack; a memory; and a transceiver. The host stack and the controller stack are connected by a Host Controller Interface (HCI).

In step S1801, the second device receives, from a first device, a single group poll packet associated with one Isochronous Interval (ISO Interval), wherein the ISO Interval comprises a plurality of Subevent intervals.

In step S1802, the second device, in response to the single group poll packet, transmits, to the first device, a plurality of response packets corresponding to each of the plurality of Subevent intervals, wherein the group poll packet operates as a single poll for an entirety of the plurality of Subevent intervals.

According to various embodiments of the present disclosure, the group poll packet comprises an Output Report of the first device.

According to various embodiments of the present disclosure, the Output Report comprises information for vibration of the at least one second device, and the group poll packet is received including the Output Report once per a plurality of ISO Intervals.

According to various embodiments of the present disclosure, the plurality of response packets comprise an Input Report of the second device.

According to various embodiments of the present disclosure, the Input Report comprises a Simple repetition of a same report or a Historic repetition of a previous report for ensuring reliability.

According to various embodiments of the present disclosure, when the second device belongs to a plurality of second devices, the plurality of response packets are transmitted from the plurality of second devices to the first device in an interleaving manner.

According to various embodiments of the present disclosure, the embodiments of FIG. 18 further comprises: receiving, from the first device, a Periodic Advertising (PA) packet; and
transmitting, to the first device, an Acknowledgment (Ack) signal indicating that synchronization to the PA packet is completed, wherein, in response to the Ack signal, at least a part of the PA packet (AUX_EXT_IND or AUX_ADV_IND) is not received.

According to various embodiments of the present disclosure, a wireless device is provided in a short-range wireless communication system. The wireless device includes: a first processor corresponding to a host stack; a second processor corresponding to a second controller stack; a memory; and a transceiver. The host stack and the controller stack are connected by a Host Controller Interface (HCI). The memory may be configured to store instructions for performing the operation method of the second device according to FIG. 18 based on being executed by the first processor and the second processor.

According to various embodiments of the present disclosure, a control device controlling the wireless device is provided in the short-range wireless communication system. The control device includes at least one processor; and at one memory operably accessing the at least one processor. The at least one memory may be configured to store instructions for performing the operation method of the second device according to FIG. 18 based on being executed by the at least one processor.

According to various embodiments of the present disclosure, provided are one or more non-transitory computer readable media (CRM) storing one or more instructions. The one or more instructions may perform operations based on being executed by one or more processors, and the operations may include the operation method of the second device according to FIG. 18.

Claims set forth in various embodiments of the present disclosure may be combined in various schemes. For example, technical features of method claims of various embodiments of the present disclosure may be combined and implemented as a device, and technical features of device claims of various embodiments of the present disclosure may be combined and implemented as a method. Further, the technical features of the method claims and the technical features of the device claims of various embodiments of the present disclosure may be combined and implemented as the device, and the technical features of the method claims and the technical features of the device claims of various embodiments of the present disclosure may be combined and implemented as the method.

1. A method performed by a first device in a short-range wireless communication system, the method comprising:
transmitting, to at least one second device, a single group poll packet associated with one Isochronous Interval (ISO Interval), wherein the ISO Interval comprises a plurality of Subevent intervals; and
in response to the single group poll packet, receiving, from the at least one second device, a plurality of response packets corresponding to each of the plurality of Subevent intervals,
wherein the group poll packet operates as a single poll for an entirety of the plurality of Subevent intervals.

2. The method of claim 1, wherein the group poll packet comprises an Output Report of the first device.

3. The method of claim 2, wherein the Output Report comprises information for vibration of the at least one second device, and
wherein the group poll packet is transmitted including the Output Report once per a plurality of ISO Intervals.

4. The method of claim 1, wherein the plurality of response packets comprise an Input Report of the at least one second device.

5. The method of claim 4, wherein the Input Report comprises a Simple repetition of a same report or a Historic repetition of a previous report for ensuring reliability.

6. The method of claim 1, wherein, when the at least one second device is a plurality of second devices, the plurality of response packets are received from the plurality of second devices in an interleaving manner.

7. The method of claim 1, further comprising:
transmitting, to the at least one second device, a Periodic Advertising (PA) packet;
receiving, from the at least one second device, an Acknowledgment (Ack) signal indicating that synchronization to the PA packet is completed; and
in response to the Ack signal, discontinuing transmission of at least a part of the PA packet (AUX_EXT_IND or AUX_ADV_IND).

8. A method performed by a second device in a short-range wireless communication system, the method comprising:
receiving, from a first device, a single group poll packet associated with one Isochronous Interval (ISO Interval), wherein the ISO Interval comprises a plurality of Subevent intervals; and
in response to the single group poll packet, transmitting, to the first device, a plurality of response packets corresponding to each of the plurality of Subevent intervals,
wherein the group poll packet operates as a single poll for an entirety of the plurality of Subevent intervals.

9. The method of claim 8, wherein the group poll packet comprises an Output Report of the first device.

10. The method of claim 9, wherein the Output Report comprises information for vibration of the at least one second device, and
wherein the group poll packet is received including the Output Report once per a plurality of ISO Intervals.

11. The method of claim 8, wherein the plurality of response packets comprise an Input Report of the second device.

12. The method of claim 11, wherein the Input Report comprises a Simple repetition of a same report or a Historic repetition of a previous report for ensuring reliability.

13. The method of claim 8, wherein, when the second device belongs to a plurality of second devices, the plurality of response packets are transmitted from the plurality of second devices to the first device in an interleaving manner.

14. The method of claim 8, further comprising:
receiving, from the first device, a Periodic Advertising (PA) packet; and
transmitting, to the first device, an Acknowledgment (Ack) signal indicating that synchronization to the PA packet is completed,
wherein, in response to the Ack signal, at least a part of the PA packet (AUX_EXT_IND or AUX_ADV_IND) is not received.

15. A first device (central device) in a short-range wireless communication system, the first device comprising:
a first processor corresponding to a host stack;
a second processor corresponding to a controller stack;
a memory; and
a transceiver,
wherein the host stack and the controller stack are connected via a Host Controller Interface (HCI),
wherein the memory stores instructions that, when executed by the first processor and the second processor, cause the first device to perform operations comprising:
transmitting, to at least one second device, a single group poll packet associated with one Isochronous Interval (ISO Interval), wherein the ISO Interval comprises a plurality of Subevent intervals; and
receiving, from the at least one second device, a plurality of response packets corresponding to each of the plurality of Subevent intervals, in response to the single group poll packet,
wherein the group poll packet operates as a single poll for an entirety of the plurality of Subevent intervals.
